(19) United States
(12) Patent Application Publication
(10) Pub. No.: US 2026/0340368 A1
(43) Pub. Date: Oct. 29, 2026

(54) METHOD OF LIGHTWEIGHTING NEURAL NETWORK AND SYSTEM THEREFOR

(71) Applicant: UNIVERSITY-INDUSTRY COOPERATION GROUP OF KYUNG HEE UNIVERSITY, Yongin-si (KR)

(72) Inventors: Ik Joon CHANG, Seoul (KR); Dong Young LEE, Gwangju-si (KR); Seung Kyu CHOI, Yongin-si (KR)

(21) Appl. No.: 19/459,705

(22) Filed: Jan. 26, 2026

(30) Foreign Application Priority Data
Apr. 28, 2025 (KR) 10-2025-0055334

(51) Int. Cl. G06N 3/0495

(52) U.S. Cl. CPC G06N 3/0495

(57) ABSTRACT

Provided are a method of lightweighting a neural network and a system therefor. A method of lightweighting a neural network according to some embodiments may include: obtaining a plurality of bit strings having an integer format by performing quantization processing on a trained neural network model; identifying one or more common truncation points by analyzing the bit strings based on a target bit width; and generating compressed bit strings corresponding to the bit strings by performing the compression processing of truncating the bit strings according to the identified common truncation points. According to this method, by performing additional lightweighting through compression processing, the memory usage and computational cost of the neural network model can be significantly reduced, and as a result, the utilization of the neural network model can be significantly increased.

### CROSS REFERENCE TO RELATED APPLICATION

This application claims priority to Korean Patent Application No. 10-2025-0055334, filed on Apr. 28, 2025, in the Ministry of Intellectual Property (MOIP) of the Republic of Korea, the disclosure of which is incorporated herein by reference.

### STATEMENT REGARDING SPONSORED RESEARCH OR DEVELOPMENT

The present disclosure was carried out with the support of the AI Semiconductor-Based K-Cloud Technology Development Program funded by the Ministry of Science and ICT of the Republic of Korea and administered by the Institute of Information & Communications Technology Planning & Evaluation (IITP) (Project ID: RS-2025-02273157; Project Title: Development of Low-Power Learning and Inference Technologies Based on AI Semiconductors; Project Period: Apr. 1, 2025-Dec. 31, 2029)

### BACKGROUND OF THE DISCLOSURE

### Field of the Disclosure

The present disclosure relates to a technology for lightweighting a neural network model using a quantization technique or the like.

### Description of the Related Art

Large Language Models (LLMs) are attracting attention by showing excellent performance in various fields such as natural language processing and automatic text generation. However, since LLMs include a vast amount of parameters, high memory usage and computational costs occur during an inference process, which acts as a main factor making actual deployment and operation of the model difficult in resource-limited environments.

As a representative approach for solving such problems, a quantization technique is being utilized. Quantization can effectively reduce memory usage and computational costs required during inference by converting the representation precision of model parameters from a floating-point format (e.g., 16-bit floating point) to a low-bit integer format. Quantization methods are largely classified into Post-Training Quantization (PTQ), which is applied as post-processing to a trained model, and Quantization Aware Training (QAT), which considers precision reduction during a training process, and the former method is mainly utilized due to the problem of high re-training costs.

However, the conventional PTQ technique has a clear limitation in securing lightweighting performance while maintaining the accuracy of the model due to information loss occurring according to the reduction of representation precision. For example, when quantizing an LLM by applying the conventional technique, intensive information loss occurs in data (e.g., activation values, etc.) which have a wide dynamic range and in which outliers may exist, which can cause a problem where model accuracy rapidly degrades. Accordingly, there is a demand for the development of a lightweighting technology capable of minimizing degradation of model accuracy even in a low-bit quantization environment.

### SUMMARY OF THE DISCLOSURE

Therefore, the present disclosure has been made in view of the above problems, and it is an object of the present disclosure to provide a method of effectively quantizing and lightweighting a neural network model into a low-bit integer format (e.g., a 4-bit integer); and a system therefor.

It is another object of the present disclosure to provide a structure of a dedicated operator applicable to a lightweight neural network model; and a method of operating the dedicated operator.

The technical problems to be solved by the present disclosure are not limited to the above-mentioned technical problems, and other technical problems not mentioned herein will be clearly understood by those skilled in the art from the following description.

In accordance with an aspect of the present disclosure, the above and other objects can be accomplished by the provision of a method of lightweighting a neural network, wherein the method is performed by at least one processor, the method including: obtaining a plurality of bit strings having an integer format by performing quantization processing on a trained neural network model; identifying one or more common truncation points by analyzing the bit strings based on a target bit width, wherein the target bit width indicates a target precision related to the quantization processing and compression processing; and generating compressed bit strings corresponding to the bit strings by performing the compression processing of truncating the bit strings according to the identified common truncation points.

In some embodiments, the obtaining of the plurality of bit strings may include: quantizing a weight parameter value of the trained neural network model into an 8-bit integer format; and quantizing an activation value of the trained neural network model into a 16-bit integer format.

In some embodiments, the neural network model may be an attention-based model, and the obtaining of the plurality of bit strings may include: quantizing a Key-related numerical value of the trained neural network model into an 8-bit or 16-bit integer format; and quantizing a Value-related numerical value of the trained neural network model into an 8-bit or 16-bit integer format.

In some embodiments, the neural network model may be an attention-based model, targets of the quantization processing and the compression processing may include a Query matrix and a Key matrix, and as a result of the quantization processing and the compression processing, a multiplication operation between the Query matrix and the transposed Key matrix may be performed on an integer basis.

In some embodiments, the target bit width may be set to 4 bits.

In some embodiments, the integer format may be a sign-magnitude format, and the identifying of the one or more common truncation points may include: detecting a position of a leading bit having a bit value of 1 in an OR bit string of the bit strings; and determining the one or more common truncation points based on the detected position and the target bit width.

In some embodiments, the integer format may be a sign-magnitude format, the one or more common truncation points may include a first point; and a second point located in a lower bit direction of the first point, and the generating of the compressed bit strings may include: removing an upper bit string of the first point from a magnitude field of a specific bit string by performing truncation at the first point; removing a lower bit string of the second point from the magnitude field by performing truncation at the second point; and generating a compressed bit string corresponding to the specific bit string by combining a sign bit of the specific bit string and a significant bit string located between the first point and the second point.

In some embodiments, the integer format may be a sign-magnitude format, and the generating of the compressed bit strings may include: removing a first lower bit string of a first common truncation point from a magnitude field of each of the bit strings by performing truncation at the first common truncation point; and recording a value, based on a length of the first lower bit string, in a first flag field shared among the bit strings.

In some embodiments, the bit strings may belong to a first group, and the method may further include: obtaining other bit strings belonging to a second group; removing a second lower bit string of a second common truncation point from a magnitude field of each of the other bit strings by performing truncation at the second common truncation point of the other bit strings; and recording a value, based on a length of the second lower bit string, in a second flag field shared among the other bit strings.

In some embodiments, a size of the first group may be determined based on a target memory usage, which is set for the trained neural network model, in relation to the quantization processing and the compression processing.

In some embodiments, a size of the first group may be determined based on a target accuracy, which is set for the trained neural network model, in relation to the quantization processing and the compression processing.

In some embodiments, the first group may be formed by selecting the bit strings whose bit pattern similarity is equal to or greater than a reference value.

In some embodiments, the integer format may be a sign-magnitude format, and the generating of the compressed bit strings may include: obtaining an initial compressed bit string by truncating a specific bit string; and generating a compressed bit string corresponding to the specific bit string by performing a rounding operation at a least significant bit of the initial compressed bit string.

In some embodiments, when all bit values of a magnitude field in the initial compressed bit string are 1, an operation of removing the least significant bit may be performed instead of the rounding operation.

In some embodiments, the method may further include: obtaining a first compressed bit string and a second compressed bit string respectively corresponding to a first operand and second operand on which a multiplication operation is performed in the neural network model; inputting the first compressed bit string and the second compressed bit string to an integer multiplier; calculating a shift value by summing a value of a first flag field associated with the first compressed bit string and a value of a second flag field associated with the second compressed bit string, wherein a value related to a length of a lower bit string of the first compressed bit string removed from a bit string of the first operand is recorded in the first flag field, and a value related to a length of a lower bit string of the second compressed bit string removed from a bit string of the second operand is recorded in the second flag field; and performing a bit shift operation by inputting an output of the integer multiplier and the shift value to a barrel shifter.

In accordance with another aspect of the present disclosure, provided is a neural network-lightweighting system, including: one or more processors; and a memory storing a computer program executed by the one or more processors, wherein the computer program includes instructions for: obtaining a plurality of bit strings having an integer format by performing quantization processing on a trained neural network model; identifying one or more common truncation points by analyzing the bit strings based on a target bit width, wherein the target bit width indicates a target precision related to the quantization processing and compression processing; and generating compressed bit strings corresponding to the bit strings by performing the compression processing of truncating the bit strings according to the identified common truncation points.

In accordance with yet another aspect of the present disclosure, provided is a computer program stored in a computer-readable recording medium and coupled with a processor of a computer to execute operations including: obtaining a plurality of bit strings having an integer format by performing quantization processing on a trained neural network model; identifying one or more common truncation points by analyzing the bit strings based on a target bit width, wherein the target bit width indicates a target precision related to the quantization processing and compression processing; and generating compressed bit strings corresponding to the bit strings by performing the compression processing of truncating the bit strings according to the identified common truncation points.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is an exemplary diagram for explaining the operation of a neural network-lightweighting system according to some embodiments of the present disclosure at a system level;

FIG. 2 is an exemplary diagram for further explaining the operation of the neural network-lightweighting system according to some embodiments of the present disclosure;

FIG. 3 is an exemplary flowchart illustrating a method of lightweighting a neural network according to some embodiments of the present disclosure;

FIG. 4 is an exemplary diagram for explaining a detailed process of the step of obtaining bit strings shown in FIG. 3;

FIGS. 5 and 6 are exemplary diagrams for explaining a detailed process of the step of identifying a common truncation point shown in FIG. 3;

FIGS. 7 to 9 are exemplary diagrams for explaining a detailed process of the step of generating a compressed bit string shown in FIG. 3;

FIG. 10 is a diagram for explaining an application example of the method of lightweighting a neural network according to some embodiments of the present disclosure;

FIGS. 11, 12A, and 12B are exemplary diagrams for explaining the structure and operating principle of a dedicated operator according to some embodiments of the present disclosure; and

FIG. 13 illustrates an exemplary computing device capable of implementing the neural network-lightweighting system according to some embodiments of the present disclosure.

### DETAILED DESCRIPTION OF THE DISCLOSURE

Hereinafter, various embodiments of the present disclosure will be described in detail with reference to the accompanying drawings. Advantages and features of the present disclosure, and methods for achieving them will become apparent with reference to the embodiments described below in detail in conjunction with the accompanying drawings. However, the technical spirit of the present disclosure is not limited to the following embodiments and can be implemented in various different forms, and the following embodiments are only provided to make the technical spirit of the present disclosure complete and to fully inform those skilled in the art to which the present disclosure pertains of the scope of the present disclosure, and the technical spirit of the present disclosure is defined only by the scope of the claims.

When it is determined that a detailed description of related known components or functions may obscure the subject matter of the present disclosure in describing various embodiments of the present disclosure, the detailed description thereof will be omitted.

Unless otherwise defined, terms (including technical and scientific terms) used in the following embodiments can be used in a sense that can be commonly understood by those skilled in the art to which the present disclosure pertains, but this may vary depending on the intention of a technician working in the related field, precedents, or the emergence of new technologies. Terms used in the present disclosure are for describing embodiments and are not intended to limit the scope of the present disclosure.

Singular expressions used in the following embodiments include plural concepts unless the context clearly specifies that they are singular. Also, plural expressions include singular concepts unless the context clearly specifies that they are plural.

In addition, terms such as first, second, A, B, (a), and (b) used in the following embodiments are only used to distinguish one component from another component, and the nature, order, or sequence of the corresponding component is not limited by the term.

Components described using terms such as part, unit, module, block, ~or, or ~er in the following embodiments and functional blocks shown in the drawings may be implemented in the form of software, hardware, or a combination thereof. Software may include, for example, machine code, firmware, embedded code (or software), application software, or a combination thereof. Also, hardware may include, for example, electrical circuits, electronic circuits, processors, computers, integrated circuits, integrated circuit cores, passive elements, or a combination thereof. As a more specific example, a part, a unit, a module, etc. may include components, such as software components, object-oriented software components, class components, and task components, processes, functions, attributes, procedures, subroutines, segments of program code, drivers, firmware, microcode, circuits, data, databases, data structures, tables, arrays, and variables.

Hereinafter, various embodiments of the present disclosure will be described in detail with reference to the accompanying drawings.

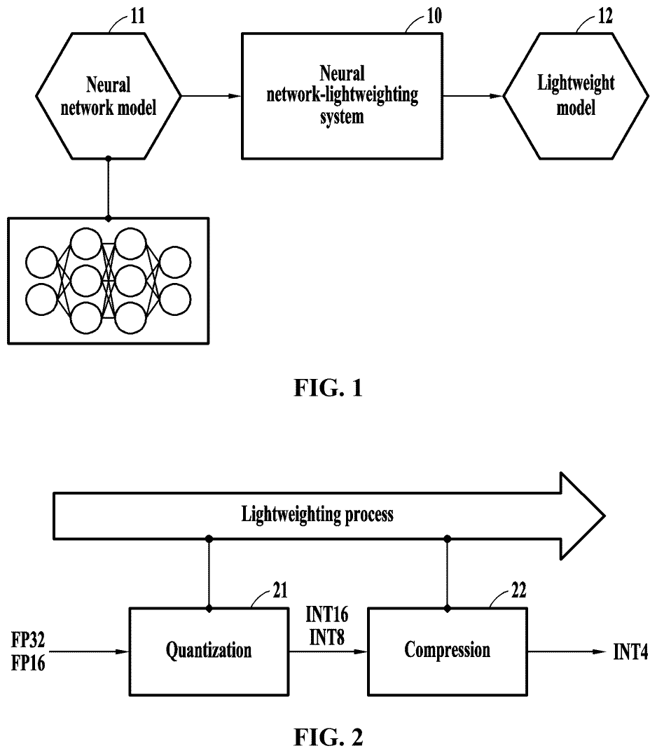

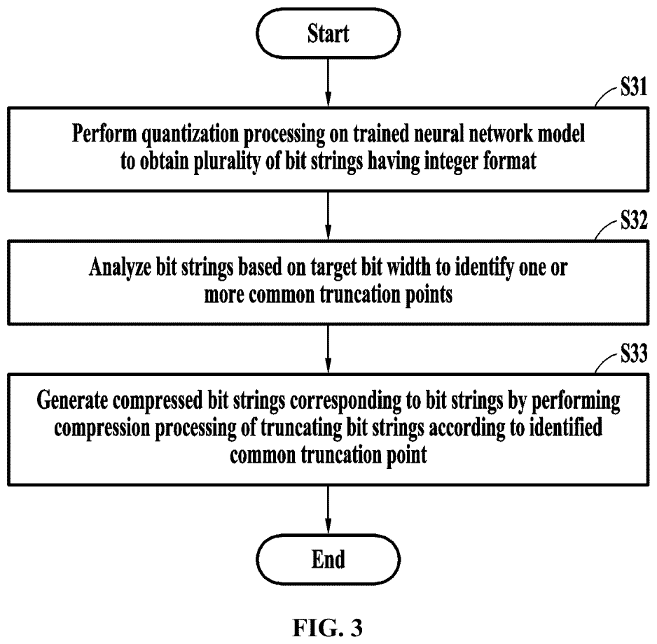

FIG. 1 is an exemplary diagram for describing an operation of the neural network-lightweighting system 10 according to some embodiments of the present disclosure at a system level, and FIG. 2 is an exemplary diagram for further describing the operation of the neural network-lightweighting system 10. In drawings such as FIG. 2, ‘FP’ denotes a floating-point format (or representation), and ‘INT’ denotes an integer format (e.g., ‘FP16’ denotes a 16-bit floating-point format).

As shown in FIG. 1, the neural network-lightweighting system 10 is a computing device/system that may effectively realize lightweighting of a trained neural network model 11. For example, the neural network-lightweighting system 10 may generate a lightweight model 12 (i.e., a lightweighted neural network model) by quantizing weight parameter values, activation values, and the like of a floating-point format (e.g., 16-bit or 32-bit floating-point, etc.) possessed by the neural network model 11 into a low-bit integer format (e.g., 8-bit or 4-bit integer, etc.). Accordingly, memory usage and computational cost of the neural network model 11 may be significantly reduced, and utilization thereof may be significantly increased. In the following description, the trained neural network model 11 may be abbreviated as a ‘neural network model’.

For reference, the lightweight model 12 (lightweight model or compressed model) may be named as a ‘quantization (quantized) model’, an ‘integer-based model’, a ‘low-precision model’, a ‘compression (compressed) model’, or the like in some cases.

In addition, the neural network-lightweighting system 10 may be named as a ‘neural network quantization device/system’, a ‘neural network compression device/system’, or the like in some cases, and may be abbreviated as a ‘quantization system’, a ‘lightweighting system’, a ‘compression system’, or the like.

The neural network model 11 is a neural network-based trained (or pre-trained) model which is a target of lightweighting/quantization, and may be, for example, a model possessing parameters of a floating-point format (or real-number format). The neural network model 11 may include, for example, a model based on an Artificial Neural Network (ANN), a Convolutional Neural Network (CNN), and a Recurrent Neural Network (RNN), an attention-based model such as a transformer, a diffusion model, and the like without limitation. As a more specific example, the neural network model 11 may be a Large Language Model (LLM) based on a transformer architecture, but the scope of the present disclosure is not limited thereto.

Specifically, as shown in FIG. 2, the neural network-lightweighting system 10 may realize lightweighting of the neural network model 11 through a lightweighting process composed of a quantization step 21 and a compression step 22.

In the quantization step 21, the neural network-lightweighting system 10 may quantize numerical values of a floating-point format (e.g., 16-bit or 32-bit floating-point, etc.) possessed by the neural network model 11 into an integer format such as 16 bits or 8 bits. A specific quantization method may be any method. Since those skilled in the art will already be aware of a principle of deriving values of quantization parameters such as a scale and a zero-point based on statistics for a calibration dataset and performing quantization through this, a detailed description thereof will be omitted.

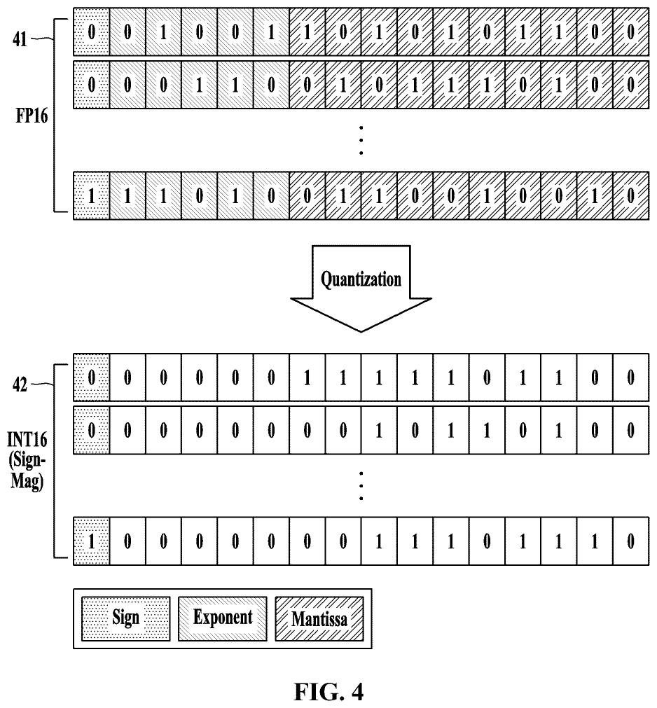

In the compression step 22, the neural network-lightweighting system 10 may perform truncation-based compression processing on a result of the quantization step 21. For example, the neural network-lightweighting system 10 may identify a common truncation point for extracting a part, which contains important information, from bit strings of an integer format (e.g., 8-bit or 16-bit integer), and generate compressed bit strings (e.g., bit strings of a 4-bit integer format), composed of significant bit strings, by performing truncation at the corresponding point. Through such compression processing, additional lightweighting may be achieved and simultaneously knowledge loss of the neural network model 11 may be minimized, which will be described in detail below with reference to drawings following FIG. 3.

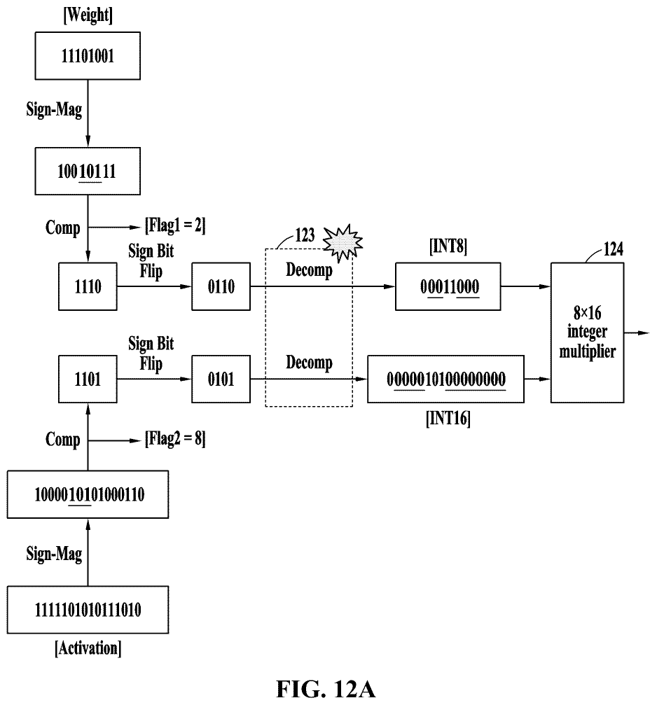

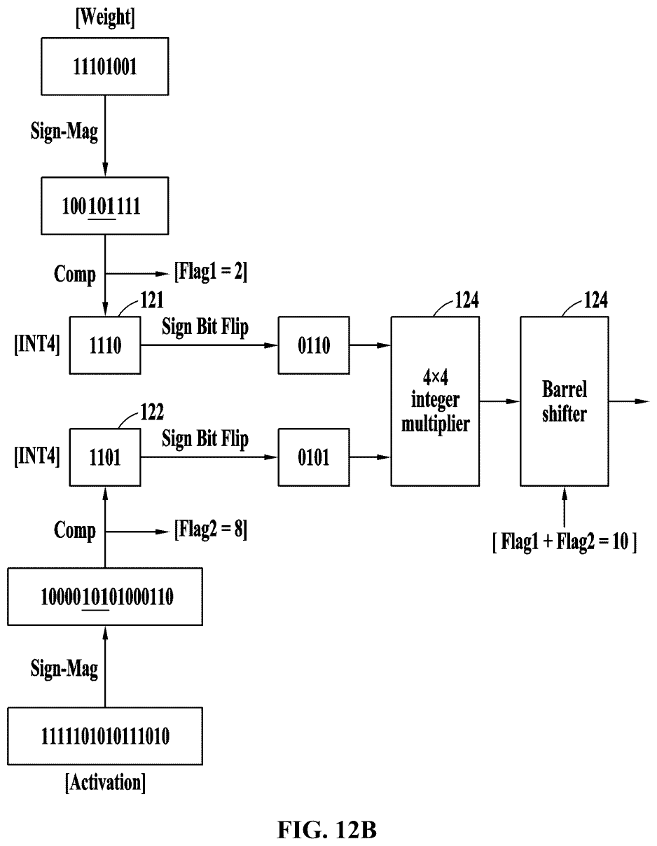

Meanwhile, the neural network-lightweighting system 10 may also efficiently perform a multiplication operation between compressed bit strings without decompression processing using a dedicated operator, which will be described in detail later with reference to FIGS. 11 to 12B.

For reference, steps 21 and 22 shown in FIG. 2 may correspond to modules constituting the neural network-lightweighting system 10. That is, it may be understood that the neural network-lightweighting system 10 is composed of a quantization module and a compression module.

The above-described neural network-lightweighting system 10 may be implemented as at least one computing device. For example, all functions of the neural network-lightweighting system 10 may be implemented in a single computing device, or a first function of the neural network-lightweighting system 10 may be implemented in a first computing device and a second function may be implemented in a second computing device. Alternatively, a specific function of the neural network-lightweighting system 10 may be implemented in a plurality of computing devices.

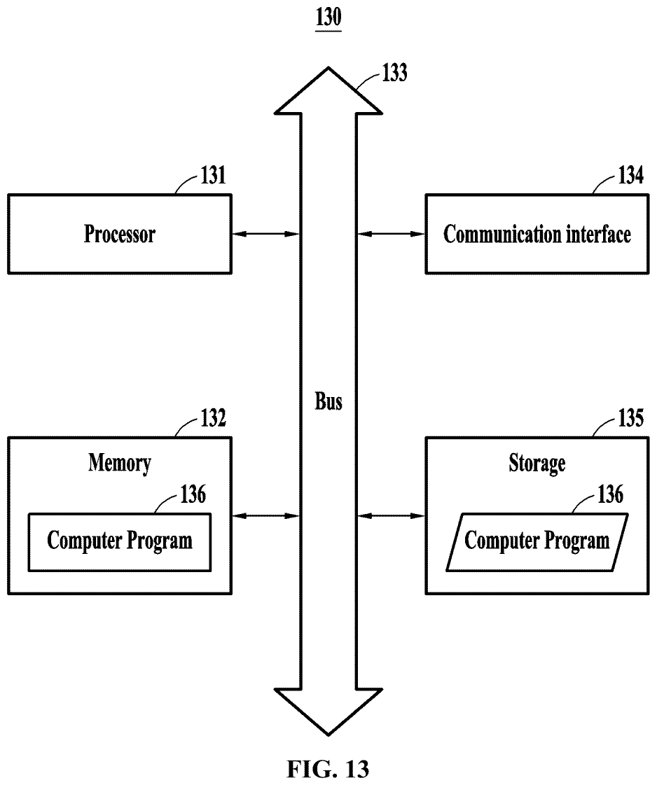

The computing device may encompass any device having a computing function, and refer to FIG. 13 for an example of such a device. Since the computing device is an aggregate in which various components (e.g., memory, processor, etc.) interact, it may be named as a ‘computing system’ in some cases. Of course, the term ‘computing system’ may also encompass a concept of an aggregate in which a plurality of computing devices interact.

So far, the operation of the neural network-lightweighting system 10 has been outlined with reference to FIGS. 1 and 2. Hereinafter, various methods that may be performed in the above-described neural network-lightweighting system 10 will be described with reference to drawings following FIG. 3.

Hereinafter, for convenience of understanding, description will be continued on the assumption that all steps/operations of methods to be described below are performed in the above-described neural network-lightweighting system 10 (e.g., at least one processor). Accordingly, when a subject of a specific step/operation is omitted, it may be understood that the corresponding step/operation is performed in the neural network-lightweighting system 10. However, in an actual environment, some steps/operations of the methods to be described below may be performed in another computing device.

Hereinafter, for convenience of description, the neural network-lightweighting system 10 will be abbreviated as a ‘system’.

FIG. 3 is an exemplary flowchart illustrating a method of lightweighting a neural network according to some embodiments of the present disclosure. However, this is only an exemplary embodiment for achieving the object of the present disclosure, and some steps may be added or deleted as necessary. In the flowchart of FIG. 3, it may be understood that step S31 corresponds to the quantization step 21 of FIG. 2, and steps S32 and S33 correspond to the compression step 22 of FIG. 2.

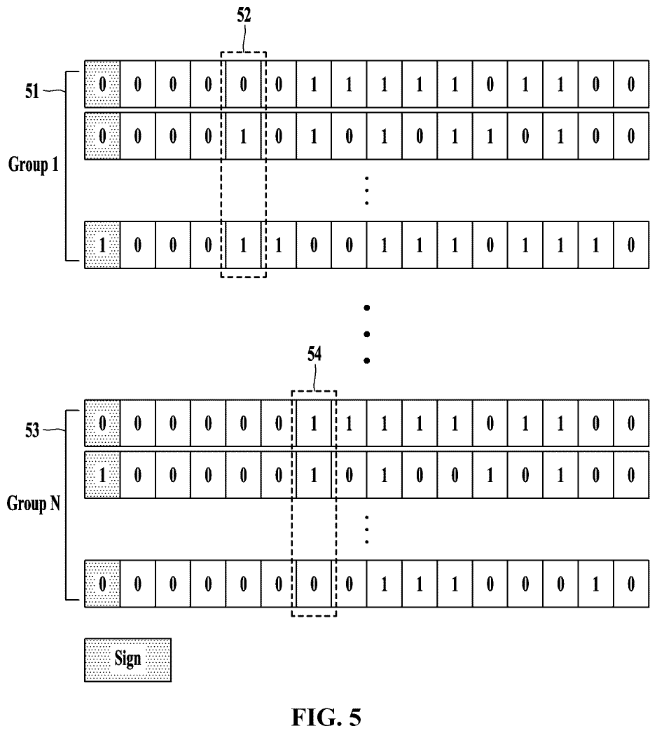

As shown in FIG. 3, the method of lightweighting a neural network according to embodiments may start at step S31 of obtaining a plurality of bit strings having an integer format by performing quantization processing on a trained neural network model. For example, the system 10 may quantize numerical values (i.e., numerical data) of a floating-point format possessed by the neural network model into an integer format. In this case, the system 10 may quantize the corresponding numerical values into a sign-magnitude format. More specifically, the system 10 may quantize the corresponding numerical values into a 2's complement format and then convert them into the sign-magnitude format. Such conversion may be performed by taking 2's complement for the remaining bit string while maintaining a sign bit when a quantized value is a negative number, but the scope of the present disclosure is not limited thereto. FIG. 4 illustrates a process in which bit strings 42 of a sign-magnitude format are obtained by quantizing numerical values 41 of a 16-bit floating-point format.

Precision setting, a specific quantization method, and the like which are applied to quantization in this step S31 may vary depending on embodiments.

In some embodiments, the system 10 may quantize weight parameter values of the neural network model into an 8-bit integer format and quantize activation values into a 16-bit integer format. This may be understood as intended to minimize information loss that may occur during a quantization process by processing activation values, which have a wider dynamic range than weight parameters, with relatively high precision. Actually, it has been reported that performance degradation hardly occurs when weight parameter values of a large language model are quantized into an 8-bit integer format and activation values are quantized into a 16-bit integer format.

In some other embodiments, the system 10 may quantize numerical values (e.g., Query/Key/Value projection matrices, Query/Key/Value matrices obtained through projection operations, etc.) related to Query, Key, and Value of an attention-based neural network model (e.g., a large language model, etc.) into an 8-bit or 16-bit integer format. In this case, a KV Cache is also quantized, and even a multiplication operation between a Query matrix and a transposed Key matrix may be performed on an integer basis during an inference process.

In some other embodiments, the neural network model may be quantized based on various combinations of the above-described embodiments.

The quantization processing of step S31 described above may be performed, for example, in units of tensors. Here, performing quantization in units of tensors means that a value of a quantization parameter is derived for each tensor that is input to each module (e.g., layer, block, etc.) of the neural network model, and quantization is individually performed for each tensor based on this. However, the scope of the present disclosure is not limited thereto.

In addition, steps S32 and S33 to be described below may be performed, for example, in units of groups. Here, the group refers to a set of quantized values (i.e., bit strings of an integer format) sharing a flag field, and a plurality of groups may be formed within numerical values (e.g., a tensor, etc.) sharing the same quantization parameter. For example, various groups may be formed even within one tensor, and this method may contribute to further minimizing information loss due to compression processing. Details thereof will be described below.

In step S32, one or more common truncation points are identified by analyzing bit strings based on a preset target bit width. Here, the target bit width means the number of bits indicating target precision that is set for the neural network model (i.e., target precision of the lightweighting process). For example, when the target precision is ‘4 bits’, the target bit width may also be set to ‘4 bits’.

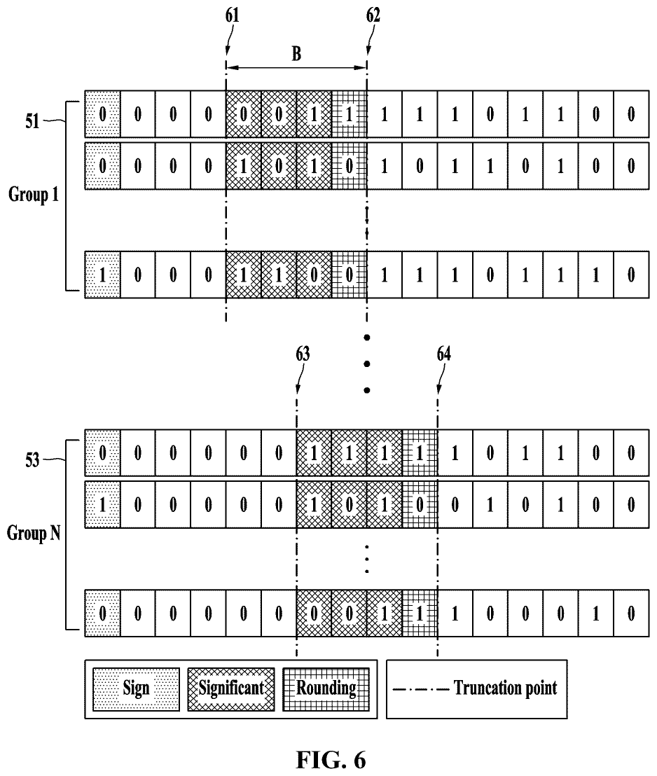

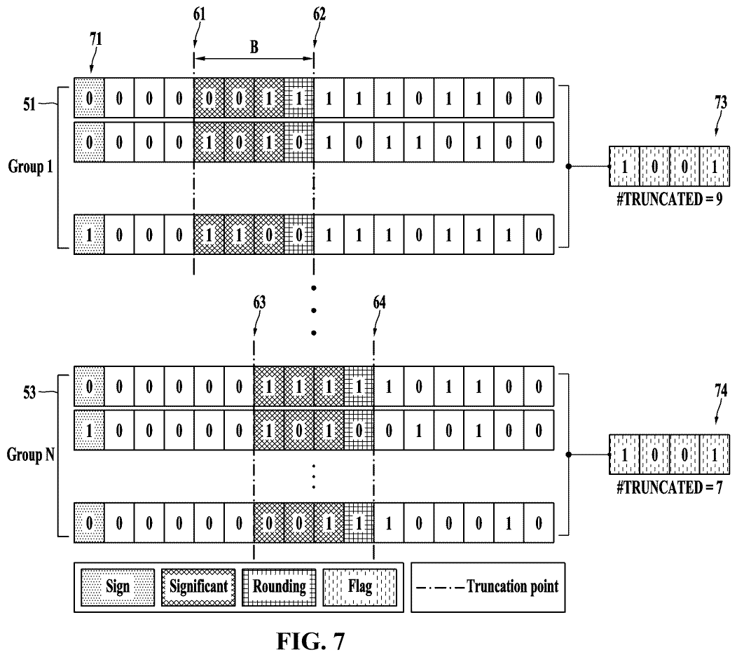

Specifically, the system 10 may detect a position of a leading bit having a bit value of 1 in an OR bit string obtained from bit strings of a sign-magnitude format, and identify a common truncation point based on the detected position and the target bit width. For better understanding, a further description will be given with reference to FIGS. 5 and 6.

FIGS. 5 and 6 are exemplary diagrams for describing a detailed process of step S32. FIGS. 5 and 6 assume a case where compression processing is performed in units of groups and the target bit width is ‘4 bits’. Hereinafter, for clarity of the present disclosure, ‘Group K’ will be referred to as a ‘K-th group’.

As shown in FIG. 5, the system 10 may detect a position 52 of a leading bit in bit strings 51 of a first group. Specifically, the system 10 may detect the position 52 of a bit (i.e., a leading bit), where ‘1’ appears for the first time, in an OR bit string (provided that it is a magnitude field excluding a sign bit) obtained by performing a ‘bitwise OR’ operation (or another operation) on the bit strings 51. The system 10 may detect a position of a leading bit in the same manner for other groups (refer to 53 and 54).

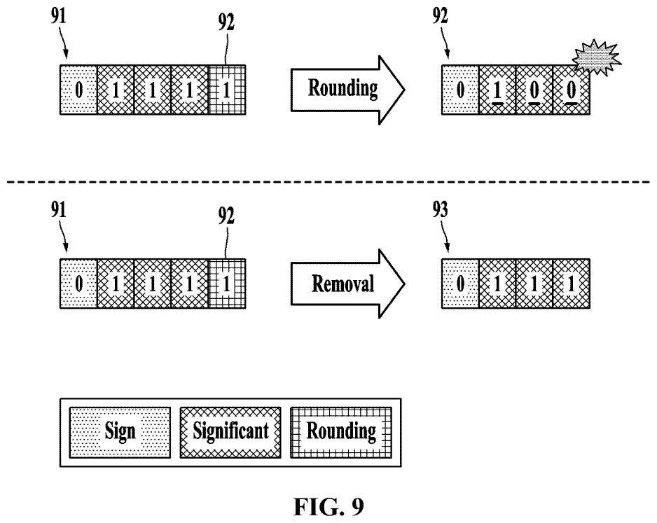

Next, as shown in FIG. 6, the system 10 may identify a boundary 61 in an upper bit direction of the leading bit (i.e., between the leading bit and an upper adjacent bit) as an upper common truncation point 62 (hereinafter, referred to as a ‘first common truncation point’), and identify a bit boundary 62 located at a position separated by a target bit width B from the corresponding point 61 as a lower common truncation point 62 (hereinafter, referred to as a ‘second common truncation point’) (i.e., the second common truncation point is a truncation point located in a lower bit direction of the first common truncation point). Here, the reason for applying the target bit width B instead of ‘target bit width B−1’ may be understood as because the least significant bit (i.e., the last bit) of a significant bit string located between the first common truncation point 61 and the second common truncation point 62 is utilized for rounding (refer to FIG. 8). The system 10 may identify a common truncation point in the same manner for other groups (refer to 53, 63, and 64).

In some cases, the system 10 may determine a common truncation point such that significant bit strings having a length corresponding to the target bit width B−1 are extracted from the magnitude field (e.g., a case where a compressed bit string corresponding to the target bit width B is generated by combining an extracted significant bit string and a sign bit without a rounding operation).

For reference, whether a rounding bit and/or a sign bit is included in the significant bit string may vary depending on a viewpoint, and hereinafter, description will be continued assuming a viewpoint that the ‘rounding bit’ is included in the significant bit string but the ‘sign bit’ is not included.

A description will be given with reference to FIG. 3 again.

In step S33, compressed bit strings corresponding to the bit strings are generated by performing compression processing of truncating the bit strings according to the identified common truncation point. For example, the system 10 may remove an upper bit string of the corresponding point by performing truncation at the first common truncation point, and remove a lower bit string of the corresponding point by performing truncation at the second common truncation point. By doing so, additional lightweighting may be effectively performed. To explain in detail, the upper bit string of the first common truncation point corresponds to an unnecessary part composed of ‘0’, and the lower bit string of the second common truncation point corresponds to a part representing a value having a numerically small size, and thus importance of information is relatively low. Accordingly, if these parts are removed, additional lightweighting for the neural network may be achieved and, simultaneously, information loss (i.e., knowledge loss of the neural network) may be minimized.

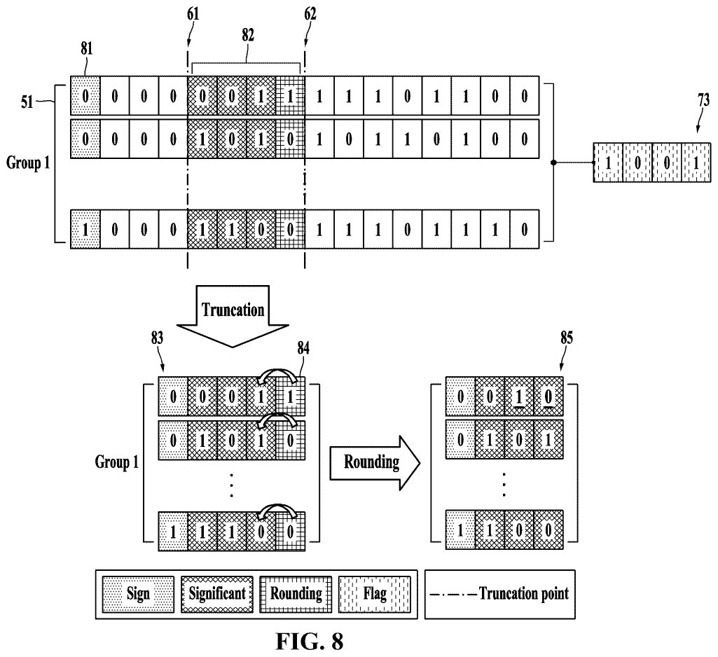

For better understanding, a detailed process of the above-described step S33 will be further described with reference to FIGS. 7 to 9.

FIGS. 7 to 9 illustrate a process in which step S33 is performed, and specifically show a process in which compression processing is performed subsequent to FIG. 6.

As shown in FIG. 7, the system 10 may extract significant bit strings 72 by performing truncation at the first common truncation point 61 and the second common truncation point 62, and generate initial compressed bit strings of a first group 51 by combining the significant bit strings 72 with sign bits 71. In this case, the system 10 may record a length value (i.e., a value indicating the number of digits of the significant bit string), related to a lower bit string of the second common truncation point 62, in a flag field 73 of the first group 51. FIG. 7 illustrates a case where ‘9’ is recorded in the flag field 73 by considering that a length of the lower bit string is ‘8’ but a rounding bit is removed through a rounding operation. The system 10 may remove a lower bit string in the same manner for other groups, and record a length-related value thereof in a flag field (e.g., 74) shared within the group. For example, the system 10 may remove a lower bit string in the same manner for an N-th group 53, and record a length-related value (e.g., 7) thereof in a flag field 74 of the N-th group 53.

Next, the system 10 may obtain final compressed bit strings by performing a rounding operation on each of the initial compressed bit strings.

Specifically, as shown in FIG. 8, the system 10 may extract a significant bit string 82 from a first bit string of the first group 51, and generate an initial compressed bit string 83 corresponding to the corresponding bit string by combining the significant bit string 82 with a sign bit 81. Next, the system 10 may obtain a final compressed bit string 85 by performing a rounding operation at a least significant bit 84 of the initial compressed bit string 83. In this case, the least significant bit 84 is removed as a result of the rounding operation, and precision of the final compressed bit string 85 is adjusted to a target precision. In FIG. 8 and the like, a bit value changed through the rounding operation is emphasized in bold and underline. The system 10 may perform the above-described processes in the same manner for other bit strings of the first group 51.

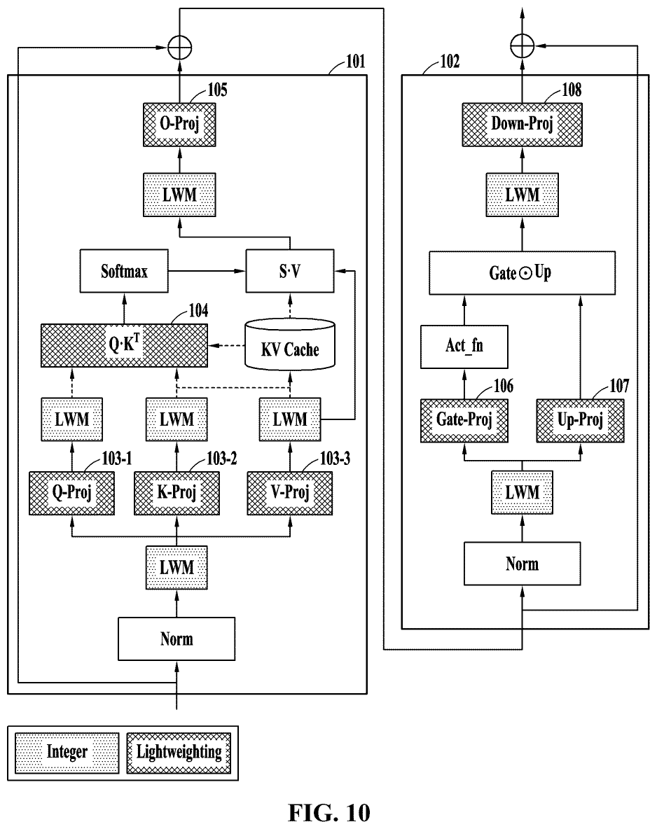

Meanwhile, when bit values of a magnitude field of an initial compressed bit string 91 are all ‘1’ as shown in an upper part of FIG. 9, an overflow may occur if the rounding operation is performed (refer to 92). To prevent such a problem, the system 10 may perform an operation/processing (e.g., an operation such as floor, truncation, etc.) of removing a rounding bit 92 for such an initial compressed bit string 91 (refer to 93).

As described above, the system 10 may perform truncation-based compression processing on bit strings in units of groups. In this case, a specific method of determining a group size, a specific method of forming a group, and the like may vary depending on embodiments.

In some embodiments, the group size may be determined based on target/allowable memory usage, which is set for the neural network model, in relation to the lightweighting process. For example, as the target memory usage is lower, the group size may be determined to be larger. This is because as the group size increases, the number of required groups decreases, and accordingly, memory usage occupied by all flag fields decreases together.

In some other embodiments, the group size may be determined based on target accuracy (i.e., performance), which is set for the neural network model, in relation to the lightweighting process. For example, as the target accuracy is higher, the group size may be determined to be smaller. This is because as the group size decreases, truncation precision increases, and accordingly, a possibility that important information (i.e., knowledge of the neural network) is lost during the compression processing decreases.

In still some other embodiments, each group may be formed based on bit pattern similarity. That is, the system 10 may select bit strings whose bit pattern similarity is equal to or greater than a reference value, and perform grouping such that they belong to the same group. The bit pattern may be defined, for example, based on a position of a leading bit having a bit value of 1, but the scope of the present disclosure is not limited thereto. According to these embodiments, as bit strings of a similar bit pattern are included in the same group, truncation precision increases, and a possibility that important information (i.e., knowledge of the neural network) is lost during the compression processing may decrease.

In still some other embodiments, a group size may be determined or a group may be formed based on various combinations of the above-described embodiments. For example, the group size may be determined by comprehensively considering target memory usage and target accuracy that are set for the neural network model.

So far, the method of lightweighting a neural network according to some embodiments of the present disclosure has been described with reference to FIGS. 3 to 9. According to the above, the neural network model (i.e., the trained model) may be lightweighted through the quantization step and the compression step. That is, by performing additional lightweighting through the compression step, memory usage and computational cost of the neural network model may be significantly reduced, and as a result, utilization of the corresponding neural network model may be significantly increased. For example, utilization of a large-scale neural network model having a vast amount of parameters such as a large language model may be significantly increased.

In addition, a first common truncation point and a second common truncation point, which is located in a lower bit direction than the first common truncation point, may be identified in bit strings of an integer format based on a position of a leading bit having a bit value of ‘1’ and a preset target bit width. And, by performing truncation based on the two points, compression may be performed such that only bit strings containing important information remain, and accordingly, knowledge loss and accuracy degradation of the neural network model may be minimized.

In addition, by performing compression processing in units of groups on bit strings sharing the same quantization parameter, knowledge loss and accuracy degradation of the neural network model may be further minimized.

In addition, by determining a group size based on target memory usage, target accuracy, and the like, which are set for the neural network model, in relation to the lightweighting process, an optimal group size meeting requirements may be accurately determined.

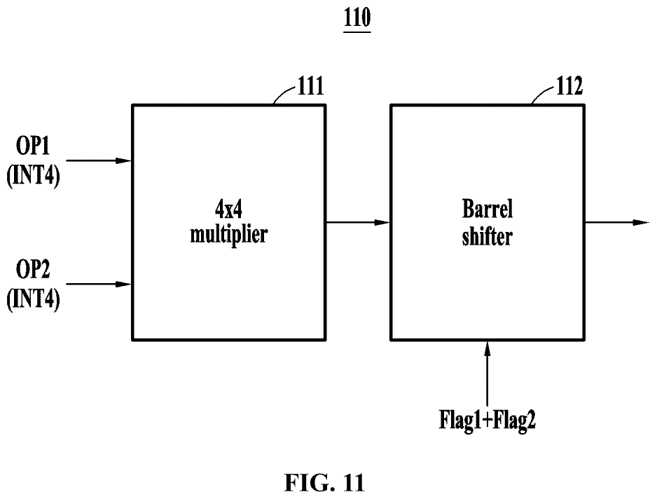

Hereinafter, a specific application example of the above-described method of lightweighting a neural network will be described with reference to FIG. 10.

FIG. 10 illustrates a case where the above-described method of lightweighting a neural network (refer to ‘LWM’) is applied to a multi-head attention block 101 and a feed-forward network block 102.

As shown in FIG. 10, the above-described method of lightweighting a neural network may be applied to results (e.g., Query/Key/Value matrices, etc.) of a query projection operation 103-1, a key projection operation 103-2, a value projection operation 103-3, and an output projection operation 105. In this case, a KV cache is quantized, and even a multiplication operation 104 between a Query matrix and a transposed Key matrix is performed on an integer basis, so that computational cost of the multi-head attention block 101 may be significantly reduced.

In addition, the above-described method of lightweighting a neural network may also be applied to results of a gate projection operation 106, an up projection operation 107, and a down projection operation 108. In this case, computational cost of the feed-forward network block 102 may also be significantly reduced.

Since those skilled in the art will already be aware of details of operations (e.g., 103-1) shown in FIG. 10, a description thereof will be omitted.

So far, an application example of the method of lightweighting a neural network according to some embodiments of the present disclosure has been described with reference to FIG. 10. Hereinafter, a dedicated operator that may be applied together with the above-described method of lightweighting a neural network will be described with reference to FIGS. 11 to 12B.

FIG. 11 is an exemplary diagram for describing a structure and operating principle of a dedicated operator 110 according to some embodiments of the present disclosure. FIG. 11 and the like assume a case where a target precision is set to ‘4 bits’.

As shown in FIG. 11, the dedicated operator 110 may be applied to perform a multiplication operation (or MAC operation, etc.) related to a lightweight model without decompression processing. For example, the dedicated operator 110 may be applied to a multiplication operation between operands (refer to ‘OP1’ and ‘OP2’) in an inference process of the lightweight model.

As shown in the drawing, the dedicated operator 110 may be configured to include an integer multiplier 111 and a barrel shifter 112. FIG. 11 illustrates a case where the integer multiplier 111 is configured to perform a multiplication operation between 4-bit integers.

The integer multiplier 111 is a module that performs a multiplication operation between two inputted operands OP1 and OP2. In this case, each of the operands OP1 and OP2 corresponds to a compressed bit string generated according to the method of lightweighting a neural network shown in FIG. 3.

The barrel shifter 112 is a module that performs a shift operation on an output of the integer multiplier 111. The barrel shifter 112 is configured to perform a bit shift operation for digit adjustment on the output of the integer multiplier 111 according to an inputted shift value. In this case, the shift value may be calculated by summing values of flag fields related to the operands OP1 and OP2 (because, in bitwise multiplication, digits increase in an additive form).

For better understanding, a further description will be given with reference to FIGS. 12A and 12B.

FIGS. 12A and 12B illustrate a comparison between a case of using the dedicated operator 110 and a case of not using the same, and illustrate a case where a first operand and a second operand are compressed bit strings of a ‘weight parameter value’ and an ‘activation value’, respectively.

As shown in FIG. 12A, when the dedicated operator is not used, decompression processing 123 should be performed first on compressed bit strings 121 and 122, and thus unnecessary overhead occurs. In addition, since a multiplication operation is performed through a multiplier 124 of a relatively complex structure, the total computational cost also increases.

For reference, in FIG. 12A, the reason why a sign bit is flipped may be understood as because the compressed bit strings 121 and 122 are ‘negative numbers’, and original sign bits may be used to determine a sign of a result of the multiplication operation.

On the other hand, a multiplication operation may be performed more efficiently when the dedicated operator 110 is used, as shown in FIG. 12B. Specifically, the integer multiplier 111 having a simple structure directly receives compressed bit strings 121 and 122 and performs a multiplication operation, and the barrel shifter 112 adjusts digits according to a sum value 125 of related flag fields. Accordingly, occurrence of overhead due to decompression processing 123 is prevented in advance, and efficiency of the entire multiplication operation may be significantly improved.

So far, the structure and operating principle of the dedicated operator 110 according to some embodiments of the present disclosure have been described with reference to FIGS. 11 to 12B. According to the above, by using the dedicated operator 110, a multiplication operation may be performed immediately without decompression processing, and as a result, computational efficiency may be significantly improved.

Hereinafter, experimental results conducted by inventors of the present disclosure will be briefly introduced.

The inventors conducted an experiment to measure performance of the above-described neural network quantization method (hereinafter, referred to as a ‘proposed method’) and an effect of a group size using a large language model ‘LLaMA’.

Specifically, the inventors measured zero-shot accuracy of an original LLaMA (hereinafter, referred to as an ‘original model’) using a disclosed dataset, and measured zero-shot accuracy in the same manner for LLaMA lightweighted to a 4-bit integer format by the proposed method (hereinafter, referred to as a ‘lightweight model’). In addition, the inventors repeatedly conducted such a performance measurement experiment while changing the group size. Experimental results are described in Table 1 below. In Table 1 below, ‘W4A8KV4’ means that numerical values related to weight parameters (W), activations (A), and Keys (K)/Values (V) were quantized into ‘4 bits’, ‘8 bits’, and ‘4 bits’, respectively, in the quantization step.

TABLE 1

| | | | Dataset | |
|---|---|---|---|---|
| Model | Classification | Group Size | PIQA | HelloSwag |
| LLaMA-2-7B | FP16 | — | 79.13 | 76.21 |
| | W4A8KV4 | 8 | 76.55 | 73.81 |
| | | 16 | 76.66 | 72.97 |
| | | 32 | 75.46 | 66.95 |

Referring to Table 1, regardless of the group size, performance of the lightweight model appeared similar to the original model. Through this, it can be confirmed that the proposed method can effectively light-weight the neural network model while minimizing knowledge loss.

In addition, it appeared that the smaller the group size, the relatively superior the performance of the lightweight model. Through this, it can be confirmed that the group size affects the performance of the lightweight model, and the neural network model can be lightweighted according to target accuracy through adjustment of the group size.

Hereinafter, an exemplary computing device 130 capable of implementing the above-described system 10 will be described with reference to FIG. 13.

FIG. 13 illustrates an exemplary hardware configuration diagram showing the computing device 130.

As shown in FIG. 13, the computing device 130 may include one or more processors 131, a bus 133, a communication interface 134, a memory 132 for loading a computer program 136 performed by the processor 131, and a storage 135 for storing the computer program 136. However, FIG. 13 illustrates only components related to embodiments of the present disclosure. Therefore, those skilled in the art to which the present disclosure pertains may appreciate that general-purpose components other than the components 131 to 136 shown in FIG. 13 may be further included. That is, the computing device 130 may further include various components in addition to the components 131 to 136 shown in FIG. 13. In addition, in some cases, the computing device 130 may be configured in a form in which some of the components 131 to 136 shown in FIG. 13 are omitted. Hereinafter, each component of the computing device 130 will be described.

The processor 131 may control overall operations of each component of the computing device 130. The processor 131 may be configured to include at least one of a Central Processing Unit (CPU), a Micro Processor Unit (MPU), a Micro Controller Unit (MCU), a Graphic Processing Unit (GPU), a Neural Processing Unit (NPU), a Tensor Processing Unit (TPU), a Vision Processing Unit (VPU), an Accelerated Processing Unit (APU), or any type of processor well known in the technical field of the present disclosure. In addition, the processor 131 may perform an operation for at least one application or program for executing specific operations/steps/methods. The computing device 130 may include one or more processors.

Next, the memory 132 may store various data, instructions, and/or information. The memory 132 may load a computer program 136 from a storage 135 to execute specific operations/steps/methods. The memory 132 may be implemented as a volatile memory such as a RAM, but the technical scope of the present disclosure is not limited thereto.

Next, the bus 133 may provide a communication function between components of the computing device 130. The bus 133 may be implemented as various types of buses such as an address bus, a data bus, and a control bus.

Next, the communication interface 134 may support wired/wireless Internet communication of the computing device 130. In addition, the communication interface 134 may support various communication methods other than Internet communication. To this end, the communication interface 134 may be configured to include a communication module well known in the technical field of the present disclosure.

Next, the storage 135 may non-transitorily store one or more computer programs 136. The storage 135 may be configured to include a non-volatile memory such as a Read Only Memory (ROM), an Erasable Programmable ROM (EPROM), an Electrically Erasable Programmable ROM (EEPROM), or a flash memory, a hard disk, a removable disk, or any type of computer-readable recording medium well known in the technical field to which the present disclosure pertains.

Next, the computer program 136 may include instructions causing the processor 131 to perform specific operations/steps/methods when loaded into the memory 132. That is, the processor 131 may perform specific operations/steps/methods by executing the loaded instructions.

For example, the computer program 136 may include instructions for performing an operation of obtaining a plurality of bit strings having an integer format by performing quantization processing on a trained neural network model, an operation of identifying one or more common truncation points by analyzing the bit strings based on a preset target bit width, and an operation of generating compressed bit strings corresponding to the bit strings by performing compression processing of truncating the bit strings according to the identified common truncation points.

As another example, the computer program 136 may include instructions for performing at least some of the operations/steps/methods described with reference to FIGS. 1 to 12B.

In the case as illustrated, the system 10 according to some embodiments of the present disclosure may be implemented through the computing device 130.

Meanwhile, in some embodiments, the computing device 130 shown in FIG. 13 may mean a virtual machine implemented based on cloud technology. For example, the computing device 130 may be a virtual machine operating in one or more physical servers included in a server farm. In this case, at least some of the processor 131, the memory 132, and the storage 135, shown in FIG. 13, may be virtual hardware, and the communication interface 134 may also be implemented as a virtualized networking element such as a virtual switch.

So far, the exemplary computing device 130 capable of implementing the system 10 according to some embodiments of the present disclosure has been described with reference to FIG. 13.

Various embodiments of the present disclosure and effects according to the embodiments have been mentioned with reference to FIGS. 1 to 13. Effects according to the technical spirit of the present disclosure are not limited to the effects mentioned above, and other effects not mentioned may be clearly understood by those skilled in the art from the following description.

In addition, even though it has been described in the above embodiments that a plurality of components are combined into one or operate in combination, the technical spirit of the present disclosure is not necessarily limited to these embodiments. That is, all of the components may operate by being selectively combined into one or more within the scope of the object of the technical spirit of the present disclosure.

According to some embodiments of the present disclosure, the neural network model (i.e., a trained model) can be lightweighted through the quantization step and the compression step. That is, by performing additional lightweighting through the compression step, the memory usage and computational cost of the neural network model can be significantly reduced, and as a result, the utilization of the corresponding neural network model can be significantly increased. For example, the utilization of a large-scale neural network model having a vast amount of parameters such as a Large Language Model (LLM) can be significantly increased.

In addition, the first common truncation point and the second common truncation point, which are located in a lower bit direction than the first common truncation point, can be identified in bit strings of an integer format based on a position of a leading bit having a bit value of ‘l’ and a preset target bit width. And, by performing truncation based on the two points, compression can be performed such that only bit strings containing important information remain, and accordingly, the knowledge loss and accuracy degradation of the neural network model can be minimized.

In addition, by performing compression processing in units of groups on bit strings sharing the same quantization parameter, the knowledge loss and accuracy degradation of the neural network model can be further minimized.

In addition, by determining a group size based on target memory usage, target accuracy, and the like, which are set for the neural network model, in relation to the lightweighting process, an optimal group size meeting requirements can be accurately determined.

Further, by using the dedicated operator composed of the integer multiplier and the barrel shifter, a multiplication operation can be performed immediately without decompression processing, and as a result, computational efficiency can be significantly improved.

Effects according to the technical spirit of the present disclosure are not limited to the effects mentioned above, and other effects not mentioned can be clearly understood by those skilled in the art from the following description.

The technical spirit of the present disclosure described above can be implemented as computer-readable codes on a computer-readable recording medium. The computer program recorded on the computer-readable recording medium can be transmitted to another computing device via a network such as the Internet and installed in the corresponding computing device, and, accordingly, can be used in the corresponding computing device.

Although operations are shown in a specific order in the drawings, it should not be understood that the operations must be performed in the specific order shown or in sequential order, or that all shown operations must be performed to obtain a desired result. In specific situations, multitasking and parallel processing may be advantageous. Although various embodiments of the present disclosure have been described with reference to the accompanying drawings above, those skilled in the art to which the present disclosure pertains can understand that the technical spirit of the present disclosure can be implemented in other specific forms without changing the technical spirit or essential features thereof. Therefore, the embodiments described above should be understood as illustrative in all respects and not limiting. The protection scope of the present disclosure should be interpreted by the following claims, and all technical spirits within the scope equivalent thereto should be interpreted as being included in the scope of rights of the technical spirit defined by the present disclosure.

What is claimed is:

1. A method of lightweighting a neural network, wherein the method is performed by at least one processor, the method comprising:
obtaining a plurality of bit strings having an integer format by performing quantization processing on a trained neural network model;
identifying one or more common truncation points by analyzing the bit strings based on a target bit width, wherein the target bit width indicates a target precision related to the quantization processing and compression processing; and
generating compressed bit strings corresponding to the bit strings by performing the compression processing of truncating the bit strings according to the identified common truncation points.

2. The method according to claim 1, wherein the obtaining of the plurality of bit strings comprises:
quantizing a weight parameter value of the trained neural network model into an 8-bit integer format; and
quantizing an activation value of the trained neural network model into a 16-bit integer format.

3. The method according to claim 1, wherein the neural network model is an attention-based model, and
the obtaining of the plurality of bit strings comprises:
quantizing a Key-related numerical value of the trained neural network model into an 8-bit or 16-bit integer format; and
quantizing a Value-related numerical value of the trained neural network model into an 8-bit or 16-bit integer format.

4. The method according to claim 1, wherein the neural network model is an attention-based model,
targets of the quantization processing and the compression processing comprise a Query matrix and a Key matrix, and
as a result of the quantization processing and the compression processing, a multiplication operation between the Query matrix and the transposed Key matrix is performed on an integer basis.

5. The method according to claim 1, wherein the target bit width is set to 4 bits.

6. The method according to claim 1, wherein the integer format is a sign-magnitude format, and
the identifying of the one or more common truncation points comprises:
detecting a position of a leading bit having a bit value of 1 in an OR bit string of the bit strings; and
determining the one or more common truncation points based on the detected position and the target bit width.

7. The method according to claim 1, wherein the integer format is a sign-magnitude format,
the one or more common truncation points comprise a first point; and a second point located in a lower bit direction of the first point, and
the generating of the compressed bit strings comprises:
removing an upper bit string of the first point from a magnitude field of a specific bit string by performing truncation at the first point;
removing a lower bit string of the second point from the magnitude field by performing truncation at the second point; and
generating a compressed bit string corresponding to the specific bit string by combining a sign bit of the specific bit string and a significant bit string located between the first point and the second point.

8. The method according to claim 1, wherein the integer format is a sign-magnitude format, and
the generating of the compressed bit strings comprises:
removing a first lower bit string of a first common truncation point from a magnitude field of each of the bit strings by performing truncation at the first common truncation point; and
recording a value, based on a length of the first lower bit string, in a first flag field shared among the bit strings.

9. The method according to claim 8, wherein the bit strings belong to a first group, and
the method further comprises:
obtaining other bit strings belonging to a second group;
removing a second lower bit string of a second common truncation point from a magnitude field of each of the other bit strings by performing truncation at the second common truncation point of the other bit strings; and
recording a value, based on a length of the second lower bit string, in a second flag field shared among the other bit strings.

10. The method according to claim 9, wherein a size of the first group is determined based on a target memory usage, which is set for the trained neural network model, in relation to the quantization processing and the compression processing.

11. The method according to claim 9, wherein a size of the first group is determined based on a target accuracy, which is set for the trained neural network model, in relation to the quantization processing and the compression processing.

12. The method according to claim 9, wherein the first group is formed by selecting the bit strings whose bit pattern similarity is equal to or greater than a reference value.

13. The method according to claim 1, wherein the integer format is a sign-magnitude format, and
the generating of the compressed bit strings comprises:
obtaining an initial compressed bit string by truncating a specific bit string; and
generating a compressed bit string corresponding to the specific bit string by performing a rounding operation at a least significant bit of the initial compressed bit string.

14. The method according to claim 13, wherein, when all bit values of a magnitude field in the initial compressed bit string are 1, an operation of removing the least significant bit is performed instead of the rounding operation.

15. The method according to claim 1, further comprising:
obtaining a first compressed bit string and a second compressed bit string respectively corresponding to a first operand and second operand on which a multiplication operation is performed in the neural network model;
inputting the first compressed bit string and the second compressed bit string to an integer multiplier;
calculating a shift value by summing a value of a first flag field associated with the first compressed bit string and a value of a second flag field associated with the second compressed bit string, wherein a value related to a length of a lower bit string of the first compressed bit string removed from a bit string of the first operand is recorded in the first flag field, and a value related to a length of a lower bit string of the second compressed bit string removed from a bit string of the second operand is recorded in the second flag field; and
performing a bit shift operation by inputting an output of the integer multiplier and the shift value to a barrel shifter.

16. A neural network-lightweighting system, comprising:
one or more processors; and
a memory storing a computer program executed by the one or more processors,
wherein the computer program comprises instructions for:
obtaining a plurality of bit strings having an integer format by performing quantization processing on a trained neural network model;
identifying one or more common truncation points by analyzing the bit strings based on a target bit width, wherein the target bit width indicates a target precision related to the quantization processing and compression processing; and
generating compressed bit strings corresponding to the bit strings by performing the compression processing of truncating the bit strings according to the identified common truncation points.

17. A computer program stored in a computer-readable recording medium and coupled with a processor of a computer to execute operations comprising:
obtaining a plurality of bit strings having an integer format by performing quantization processing on a trained neural network model;
identifying one or more common truncation points by analyzing the bit strings based on a target bit width, wherein the target bit width indicates a target precision related to the quantization processing and compression processing; and
generating compressed bit strings corresponding to the bit strings by performing the compression processing of truncating the bit strings according to the identified common truncation points.
